(19) United States
(12) Patent Application Publication
(10) Pub. No.: US 2009/0078684 A1
(43) Pub. Date: Mar. 26, 2009

(54) METHOD FOR PRODUCING A DIGITAL RIGHTS FILE DESCRIPTION

(76) Inventor: Stephane Grimault, Gradignan (FR)

Correspondence Address: ANDERSON, KILL & OLICK, P.C., 1251 AVENUE OF THE AMERICAS, NEW YORK,, NY, 10020-1182, US

(21) Appl. No.: 11/887,518

(22) PCT Filed: Apr. 4, 2006
(86) PCT No.: PCT/FR2006/050297

§ 371 Date: Sep. 27, 2007

(30) Foreign Application Priority Data
Apr. 6, 2005 (FR) 0503422

(51) Int. Cl. B23K 11/08; B23K 31/02

(52) U.S. Cl. 219/117.1; 228/221

(57) ABSTRACT

The welding of a tight envelope is performed in two stages (8, 9), with an intermediate sucking up by an appendage with holes (6, 7) to create a vacuum in an envelope and strengthen the insulation offered by the interlining (1). When the second weld (9) has been performed, the appendage having the hole may be withdrawn. An electric resistance seam weld is preferable. One can thereby use welding procedures under atmosphere and weld metallic envelopes.

This patent relates to a method for producing a thermal insulation vacuum panel.

Some insulating panels are formed as in FIG. 1, namely an insulating interlining 1 enclosed in an envelope 2 usually made up of a lower sheet 3 and an upper sheet 4, at least one of which is folded around the interlining 1 so as to adhere to the other of the sheets. A weld 5 is established between the close portions of the sheet edges 3 and 4 to insulate the volume they include and the interlining 1 from the outside. The panel may then be introduced behind a protective screen to form a thermal screen. That which is illustrated is flat, but it may be cylindrical or another shape. An insulating material commonly used for the interlining 1 is that which is referred to as microporous, meaning an agglomerated powder of a material such as silica. The sheets 3 and 4 are generally made up of two layers of polyethylene between which a layer of aluminum is inserted to increase the resistance and tightness of the sheets. The weld therefore concerns the layers of polyethylene and is easily done.

Another characteristic is that the content of the envelope 2 must be held under vacuum to preserve good insulation characteristics. The placement of the envelope 2 around the interlining 1 and its welding are therefore done under vacuum, in a chamber, according to the known method, by a simple heated clamp which softens the polyethylene.

There has been interest in using such insulating panels at temperatures higher than usual, at approximately 400° C. While the microporous interlining is still suitable, this is no longer the case for the known envelope, as the polyethylene melts. One therefore tried to replace the envelope of primarily polyethylene with other materials, but difficulties arose. Using a simple sheet of aluminum is not suitable due to difficulties in welding this metal. Other metals could be used, but their welding is done at high temperatures. It is difficult not to cause crumbling of at least a small quantity of the interlining during production, such that the silica powder is freed and reaches the welding region. It decomposes at high temperatures, and oxygen vaporization harms the quality of the welding by creating bubbles or oxides. The perfect tightness of the weld can therefore no longer be guaranteed, in particular for very low thicknesses of less than 100 microns.

Another difficulty comes from the fact that the usual methods for welding metals are done in a controlled atmosphere (neutral gases) and use, when they are automated, jointed systems, which must be lubricated, to move the welding tool along the peripheral contour of the vacuum sealed interlining. One is therefore in the awkward position of establishing welding of the envelope in the vacuum atmosphere as one can do with the polyethylene envelope, which must be replaced.

There was therefore the issue of finding an envelope material resistant at all usage temperatures and a welding method adapted to this particular context of producing a thermal insulating panel made up of an interlining and an envelope sealed by tight welding around the interlining, the interlining being under vacuum, where the freed interlining may damage the welding, with a means for producing the vacuum in the envelope while the welding would not be done under vacuum. We arrived at a method comprising the following steps:
production of the envelope using two sheets of metal with an appendage over two superimposed edges to be welded of the sheets, the appendage having holes in it,
performing a first weld under atmosphere, including the insulating interlining and the appendage in a volume internal to the envelope,
sucking up of a gaseous content of the volume internal to the envelope through the appendage,
carrying out a second welding, excluding the appendage of the internal volume, or separating it from the volume containing the interlining.

A welding method particularly adapted to this application and generally suitable for most of the metals to be considered (steel, titanium, nickel or their alloys yielding good results) is welding by electric resistance by discharging current between two toothed wheels rotational driven.

The invention will now be described in connection to the figures, in which:

FIG. 1, already described, illustrates a thermally insulating panel to be built,

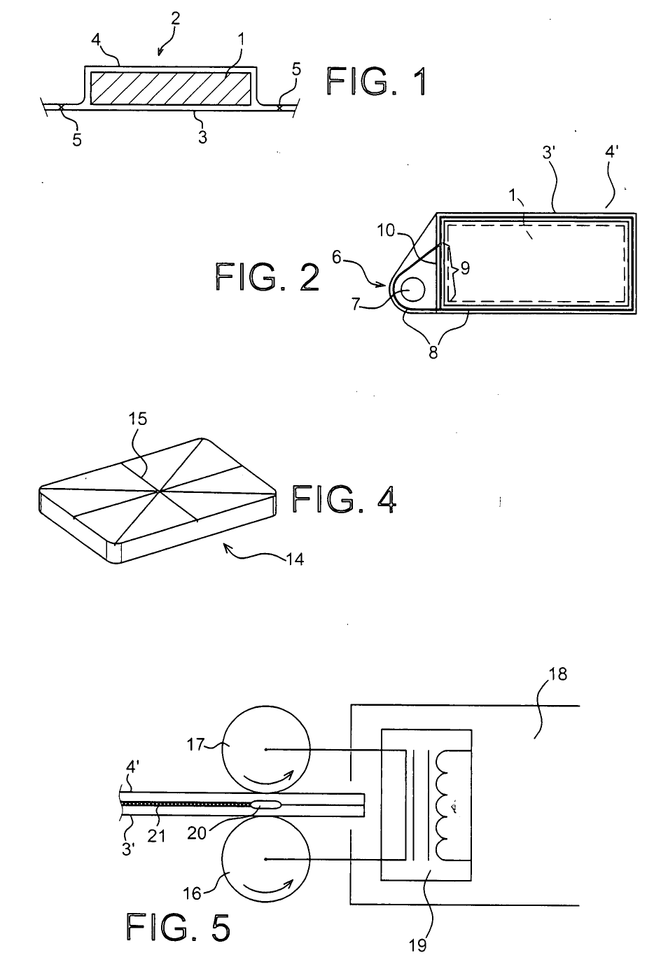

FIG. 2 illustrates the panel while explaining the steps of the production process,

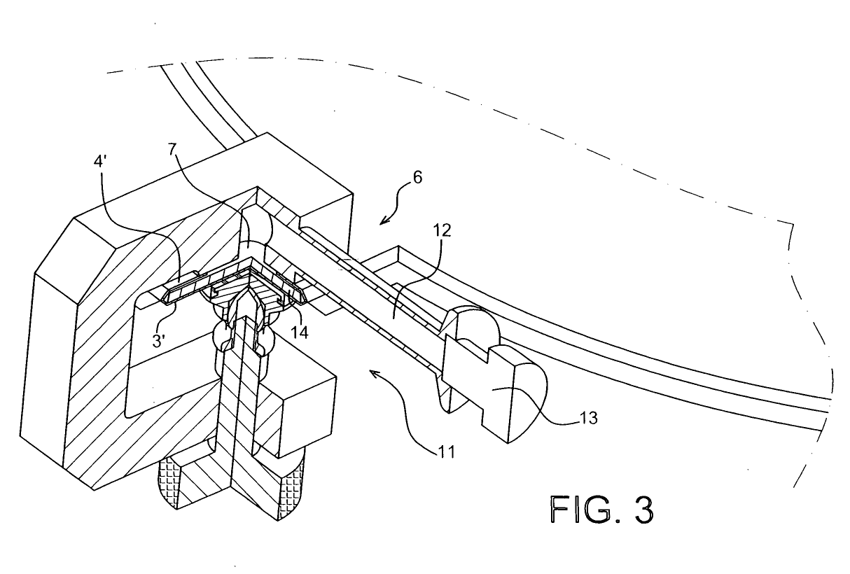

FIG. 3 illustrates the sucking device,

FIG. 4 is a detail of the wedge used,

and FIG. 5 illustrates a welding tool.

We will examine FIG. 2. To build an envelope using the method of the invention, one will also use two superimposed sheets 3′ and 4′ to enclose an internal volume comprising the interlining 1, but the lower sheet 3′, like the upper sheet 4′, will now be provided with an appendage 6 on one side of the panel, opened by a hole 7 opening into the space between the sheets 3′ and 4′ and indirectly in the volume of the interlining 8. In a first step of the invention, a first weld 8 is done according to a closed contour surrounding the interlining 1 and the hole 7, and therefore going through the outer edge of the appendage 6.

Sucking up of the gaseous content of the volume enclosed by the envelope formed by the sheets 3′ and 4′ is then undertaken by sucking through the hole 7. Lastly, a second weld 9 is made to separate the appendage 6 and the hole 7 from the rest of the envelope and completely insulate the interlining 1 from the outside, the vacuum being maintained during this second weld 9. The appendage 6 can then be cut at the line 10 to re-form an envelope edge slightly protruding from the interlining 1.

FIG. 3 illustrates the sucking method used. A vise 11 clamps the appendage 6. Its upper jaw opening onto the hole 7 is hollow and comprises a channel 12, opening in front of the hole 7 and leading to a vacuum pump 13. The sheets 3′ and 4′ are maintained sufficiently apart by a wedge 14 slid between them and which prevents the appendage 6 from curling up. The wedge 14 is provided with grooves 15 on its upper surface, under the hole 7, so as to maintain an open sucking path (FIG. 4). The vise 11 and the wedge 14 are therefore installed once the first weld 8 has been performed, and removed only after the second weld 9 has been performed.

In different tests, we used sheets 3′ and 4′ in stainless steel, titanium and nickel, weakly alloyed. These metals yielded good results. Their alloys, and possibly other metals, may be suitable.

Several welding methods were also tried, and some yielded good results for welding thin sheets, such as brazing, low-power GTA welding, particularly using plasma through a calibrated opening providing a thin ionized column, and preferably with a covering of shielding gas around the torch and a welding pool. The method best adapted to the present application, which is the most robust with regard to pollution from free silica, is, however, electric resistance seam welding, which has the particularity of developing the welding pool first at the interface between the sheets 3′ and 4′, where the electric resistance is the greatest. FIG. 5 illustrates one possible device, in which two seams 16 and 17 both depending on an arm 18 diagrammatically illustrated are disposed facing each other so as to be in contact with the sheets 3′ and 4′, respectively. The seams 16 and 17 therefore roll under and above the envelope when the arm 18 pulls them. They are both connected to an electric circuit 19, which imposes a difference in potential on them, heating, through the Joule effect, the stack of sheets 3′ and 4′ located between them. The energy is sufficient to produce a fusion pool 20 between the toothed wheels 16 and 17 and a seam weld 21 upon solidification. One of the toothed wheels can also be replaced by a fixed backing electrode bearing on the concerned sheet or on the envelope support; it would also be possible to place the toothed wheels 16 and 17 side by side, transversely or longitudinally, on the same sheet 3′ and 4′, and the fusion pool would still develop between the two sheets 3′ and 4′ and between the toothed wheels 16 and 17. These design variations belong to the art of seam welding.

1. Method for producing a thermal insulation panel made up of an interlining and an envelope sealed by welding around the interlining, the interlining being under vacuum, characterized in that the envelope is in metal and in the that method comprises the following steps:
production of the envelope with an appendage (6) on two superimposed edges of sheets (3′ and 4′) to be welded, the appendage having holes (7),
performing a first weld under atmosphere, including the interlining and the appendage (6) in a volume internal to the envelope,
sucking up of a gaseous content of the volume internal to the envelope through the appendage,
performing a second weld (9), excluding the appendage, of the internal volume.

2. Method for producing a thermal insulation panel according to claim 1, characterized in that it comprises a final step for removing the appendage.

3. Method for producing a thermal insulation panel according to claim 1, characterized in that it comprises the placement of a grooved (15) wedge (14) in the appendage, between the edges to be welded, before performing the first seam weld.

4. Method for producing a thermal insulation panel according to claim 1, characterized in that the interlining is an agglomerated silica powder.

5. Method of producing a thermal insulation panel according to claim 1, characterized in that the envelope is in a material selected from among steel, titanium, nickel or their alloys.

6. Method of producing a thermal insulation panel according to claim 1, characterized in that the welds are performed by Joule effect between one or several toothed wheels (16, 17).

7. Method for producing a thermal insulation panel according to claim 2, characterized in that it comprises the placement of a grooved (15) wedge (14) in the appendage, between the edges to be welded, before performing the first seam weld.

8. Method for producing a thermal insulation panel according to claim 2, characterized in that the interlining is an agglomerated silica powder.

9. Method for producing a thermal insulation panel according to claim 3, characterized in that the interlining is an agglomerated silica powder.

10. Method of producing a thermal insulation panel according to claim 2, characterized in that the envelope is in a material selected from among steel, titanium, nickel or their alloys.

11. Method of producing a thermal insulation panel according to claim 3, characterized in that the envelope is in a material selected from among steel, titanium, nickel or their alloys.

12. Method of producing a thermal insulation panel according to claim 4, characterized in that the envelope is in a material selected from among steel, titanium, nickel or their alloys.

13. Method of producing a thermal insulation panel according to claim 2, characterized in that the welds are performed by Joule effect between one or several toothed wheels (16, 17).

14. Method of producing a thermal insulation panel according to claim 3, characterized in that the welds are performed by Joule effect between one or several toothed wheels (16, 17).

15. Method of producing a thermal insulation panel according to claim 4, characterized in that the welds are performed by Joule effect between one or several toothed wheels (16, 17).

16. Method of producing a thermal insulation panel according to claim 5, characterized in that the welds are performed by Joule effect between one or several toothed wheels (16, 17).
